(19) United States
(12) Patent Application Publication
(10) Pub. No.: US 2007/0024576 A1
(43) Pub. Date: Feb. 1, 2007

(54) Correction arrangements for portable devices with oled displays

(76) Inventor: Paddy A.S. Hassan, London (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/585,849

(22) PCT Filed: Jan. 6, 2005
(86) PCT No.: PCT/GB05/00012

§ 371 Date: Aug. 4, 2006

(30) Foreign Application Priority Data
Jan. 13, 2004 (GB) 04006474
Nov. 23, 2004 (GB) 04257648

(51) Int. Cl. G09G 5/00

(52) U.S. Cl. 345/156

(57) ABSTRACT

Re-calibration of an OLED display of a personal device, such as a mobile phone or a laptop computer, is achieved by an optical sensing arrangement that is temporarily or permanently joined to the personal device. The sensing arrangement can comprise a connector for charging a battery of the portable device and/or a small digital camera or photocell. The re-calibration corrects for uneven aging of the OLED pixels and can occur automatically during battery re-charging.

### FIELD AND BACKGROUND OF THE INVENTION

The present invention applies to adjuncts for rechargeable portable devices that have a display, such as mobile phones and palm-held computers. Such portable devices contain batteries that need to be charged many times during the useful life of the device.

An emerging type of display being considered for mobile phones and palm-held computers is the organic light-emitting diode display (OLED display). OLED displays have the advantages of being monolithic, being self-illuminating, and being power-saving. However, OLED displays are subject to uneven degradation of the pixels during the service life of the display. The uneven degradation results in images in which the pixels are not matched with each other.

An OLED display can have, for example, red, green and blue pixels. The different colors can degrade at different rates from each other. For example the emission intensities of the red pixels may degrade at a faster or slower rate than the emission intensities of the green pixels, thus altering the fidelity of color rendering of the pixels as the pixels age. Furthermore, the pixels of a given color, for example green, may degrade at different rates from each other, causing a displayed image to be uneven even if the image is all just green,

A method of overcoming mismatch of the pixels of a display caused by ageing is known from U.S. Pat. No. 6,441,560. This is to deposit on the display matrix a sensor matrix, the sensor matrix monitoring the display matrix. Such an approach adds to the complication and cost of manufacturing the display.

Another method of overcoming mismatch of the pixels of a display caused by ageing is known from U.S. Pat. No. 6,359,758. In this case a camera on a tripod is used to calibrate the pixels of an LED sign. The procedure, while appropriate for a large expensive sign is not appropriate for a user of a mobile phone. The same patent also discloses a display having a built-in sensor detecting weak lateral light in the display. The detected light is weaker than the light emanating from the display.

Another method of overcoming mismatch of the pixels of a display caused by ageing is known from U.S. Pat. No. 6,788,003. In this case light is not sensed. Instead, pixel currents are measured to give some compensation for optical ageing.

The object of the present invention is to provide a simple arrangement by which OLED pixels of a portable device, such as a mobile phone, can be kept matched during the lifetime of the portable device.

### SUMMARY OF THE INVENTION

An object of the present invention is to reduce unevenness in the monochrome or color matrix display of a portable hand-held device.

According to the invention, there is provided a monitoring device for a rechargeable personal portable device of the type having a main body to which is attached a display, the monitoring device being coupled to a portion of the main body at least temporarily and including a light sensor that is spaced away from the display during monitoring of the display by the monitoring device.

### BRIEF DESCRIPTION OF THE DRAWINGS

FIG. 1 illustrates schematically an adjunct according to one embodiment of the invention;

FIG. 2 illustrates schematically an adjunct according to another embodiment of the invention;

FIG. 3 illustrates schematically an adjunct according to a further embodiment of the invention;

FIG. 4 illustrates schematically an adjunct according to an embodiment of the invention wherein the portable device is a palm-held computer;

FIG. 5 illustrates schematically an adjunct according to another embodiment of the invention;

FIG. 6 illustrates schematically an adjunct according to another embodiment of the invention;

FIG. 7 illustrates schematically an adjunct according to another embodiment of the invention;

FIG. 8 illustrates schematically a plan view related to FIG. 7; and

FIG. 9 illustrates schematically a further embodiment of the invention.

### DESCRIPTION

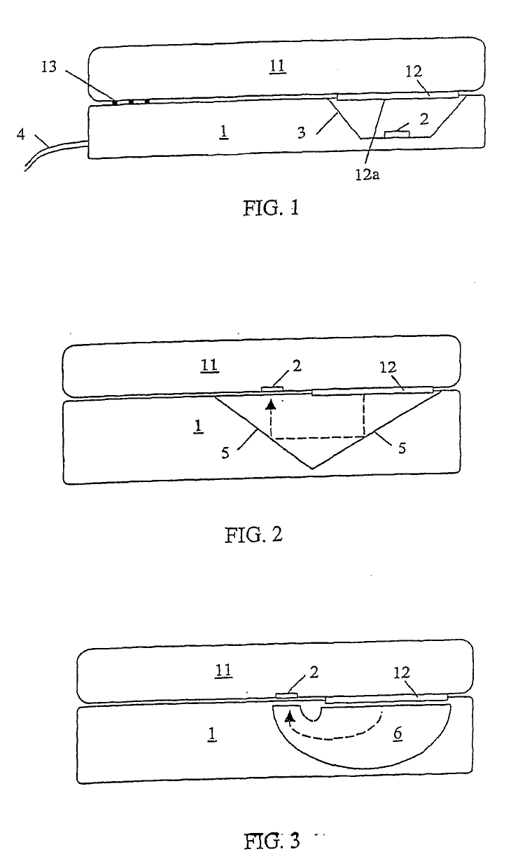

FIG. 1 illustrates an adjunct 1, arranged as a recharging cradle. Adjunct 1 has a recess containing a light-sensing device 2. Light-sensing device 2 receives light from a portable device 11 that has a matrix display 12, and that has a rechargeable battery that is not shown. Display 12 has a front face 12a. The portable device. 11 may, for example, be a mobile phone and display 12 may be an OLED matrix display. The rechargeable battery receives recharging energy from adjunct 1 via some of a set of contacts 13. A cable 4 receives power for recharging the battery and delivers the power to adjunct 1.

Before, during or after recharging of portable device 11, while it is on adjunct 1, devices I and 11 interact via one Or more of contacts 13 so that display 12 is caused to emit light from its front face 12a. The output of sensor 2, detecting the emitted light, is measured and used for calibrating the display 12, so that display 12 can be corrected for any uneven degradation of its OLED pixels. Sensor 2 is shown mounted in a reflector cup 3. The OLED-pixels-can be-energised and measured each in turn.

Sensor 2 may consist of one photocell or several photocells. Sensor 2 may comprise a red, a green and a blue photocell.

Sensor 2 can be replaced with a digital camera, in which case cup 3 can be made non-reflective. Using a camera at position 2 as the light sensor enables many pixels to be measured individually and simultaneously, but the cost of sensing becomes higher.

FIG. 2 illustrates another arrangement for adjunct 1, again in the form of a cradle. In this case rechargeable portable device 1 has attached to it a light sensing device 2. Light from display 12 is directed to light sensing device 2 by reflectors 5 incorporated in a recess in adjunct 1 for calibration.

FIG. 3 illustrates yet another arrangement for adjunct or docking station 1. In this case rechargeable portable device 11 has attached to it a light sensing device 2 and light from display 12 is directed to light sensing device 2 by an optical fibre bundle 6, incorporated in a recess in adjunct 1, which guides light from display 12 to sensor 2.

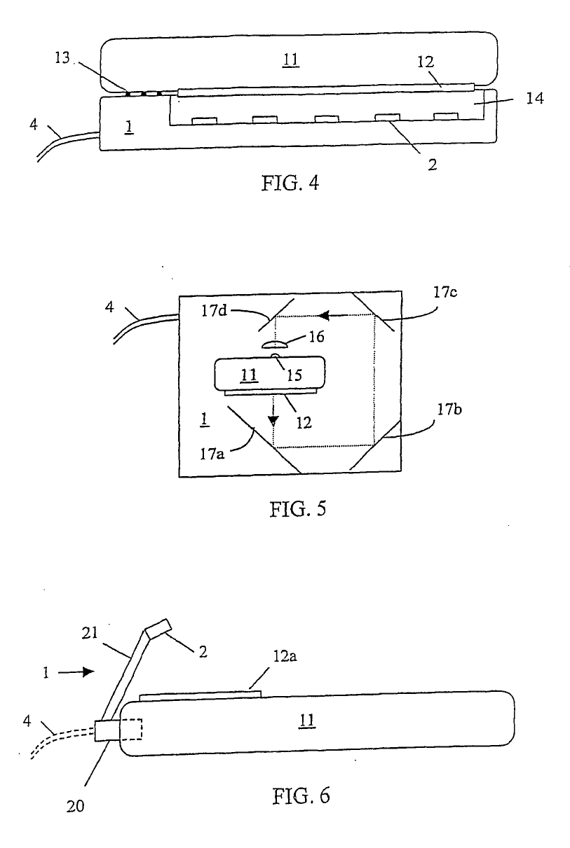

FIG. 4 illustrates an adjunct 1 in the form of a recharging cradle, and wherein the rechargeable portable device is a palm-held computer. In this case several sensors 2 are provided in hollow 14 of adjunct 1. The several sensors 2 can be connected in is parallel, or they can be sensed each separately.

In the arrangements of FIGS. 1, 4, those of contacts 13 that are necessary for battery-charging may be duplicated on the top surface of device 11, so that the user has the option, if required, of viewing display 12 during battery recharging, by flipping device 1 1 over.

FIG. 5 illustrates an adjunct according to another embodiment of the invention wherein recargeable portable device 11 comprises a digital camera having a lens 15. Device 11 is elongate in the direction into the paper. Electrical contacts under device 11, not shown, charge the batteries of device 11 using energy derived from cable 4. In this case the camera in device 11, having lens 15, serves as the optical sensor for calibration of display 12. The camera is arranged during calibration, initiated for example by device 11 or by adjunct 1, to take one or more pictures of display 12, via mirrors 17a -17d and convergent close-up lens 16. Mirrors 17a -17d and close-up lens 16 are parts of adjunct 1. Display 12 may have a length, measured into the paper, nearly equal to the length of device 11. Adjunct 1 includes locating means, not shown for positioning device 11 correctly. Device 11 can in this case be, for example, a digital camera or a combined digital camera/handheld computer, or a combined digital camera/games device.

In each of the arrangements discussed, display 12 may be a color OLED display, in which case the display may have red, green and blue pixels. A problem with red, green and blue OLED pixels is that each of the three colors degrades at a different rate from the other two, causing the color rendering of the display to deteriorate with use. The arrangements of the present invention overcome or ameliorate the problem of the color rendering changing with time. The light intensities of the red, green and blue pixels can be kept matched by the arrangements described with reference to the drawings even if the red, green and blue pixels degrade at markedly different rates from each other.

From time to time the system comprising adjunct 1 and portable device 11 corrects for unevenness that has developed in the display 12. Correction can be by a calibration process supervised by adjunct 1 or by device 11 involving measuring the light output of the display and recording correction parameters dependent on the measurements in a memory provided in device 11. The recorded information is subsequently referred to by device 11 for correcting the drives to the pixels when device 11 is being used independently of its adjunct 1.

For each of the arrangements of FIGS. 1-5 a cable for providing the power for recharging the batteries of device 11 can be connected to either adjunct 1, as illustrated in FIG. 1, or to device 11.

For each of the arrangements of FIGS. 1, 4, 5 adjunct 1 may have a plug attached to it that can connect with an electrical power socket, in which case cable 4 is not needed.

FIG. 6 illustrates a further embodiment of the invention. In this case sensor 2, sensing light from the front of display 2, is carried by connector 20 with the aid of hollow arm 21. Signals dependent on output from sensor 2 pass through arm 21 to electronics in device 11 for matching pixels of display 12. Optionally, connector 20 may have a cable 4 connected to it for recharging the batteries of device 11. The top of main body 11 comprises a keyboard, not shown.

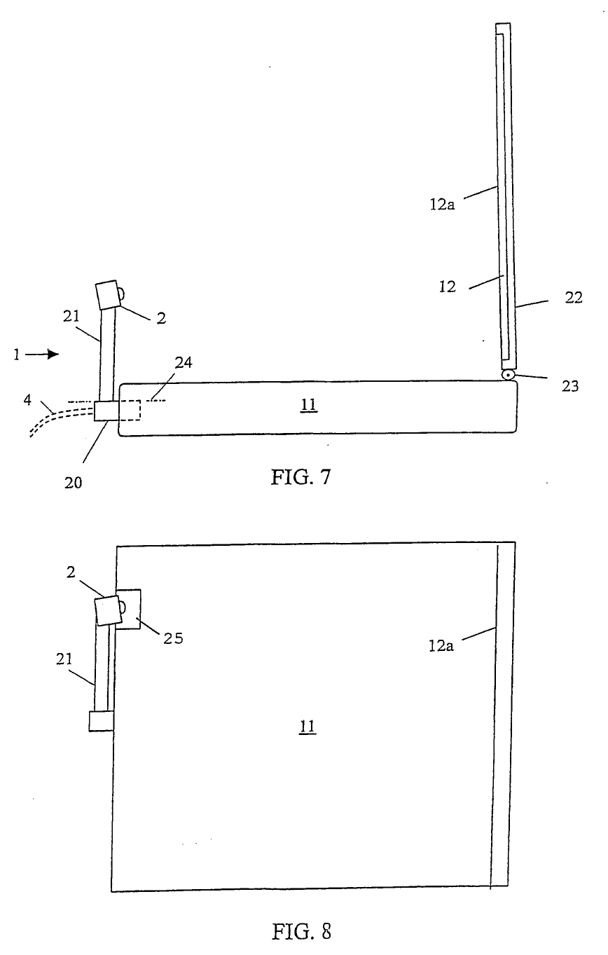

FIG. 7 illustrates a farther embodiment of the invention. In this case device 11 includes a lid 22 hinged to it at 23, the lid having attached to it a display 12. Device 11 with its hinged lid may, for example, be a laptop computer. The top of main body 1 comprises a keyboard, not shown.

Plugged into device 11 is unit 1 comprising a hollow arm 21 terminating at one end thereof in a sensor 2 and at the other end thereof in a connector 20, via which, optionally, the batteries of device 11 may be charged. Output from sensor 2 is used to correct for pixel mismatch of display 12 caused by unequal pixel ageing. Sensor 2 senses light passing out from display face 12a. Hollow arm 20 carrying sensor 2 may be hinged at its lower end for rotation, for example, about a horizontal axis 24 that is parallel to the plane of the drawing. In this case arm 21 can optionally be set parallel to the top surface of main body 11. Sensor 2 may comprise a digital camera and the camera may have a sensor matrix that is oblique to the optical axis of the lens of the camera. Rotating unit 1 of FIG. 7 may be a permanent fixture of body 11, in which case component 20 need not be a connector. FIG. 8 illustrates in plan view arm 20 parked horizontally, with sensor 2 parked in notch 25 in body 11.

In the arrangements relying on elementary sensors 2 each pixel can be individually calibrated in turn, by energising it and recording the corresponding output from sensor 2. To improve the sensitivity of light detection the pixel can be driven by a modulated signal, in which case the output of sensor 2 is fed to a circuit selective to the modulation. For example, the pixel can be turned on and of repetitively at a rate of 10,000 times per second, and the selective circuit can be made sensitive specifically to light interrupted at 10 KC. Furthermore, instead of just one display pixel being energized, sets of display pixels can each be energized simultaneously and calibrated. A set of simultaneously energized pixels may, for example be a 2×2 or a 4×2 matrix, or a 4×1 array.

To correct for just the different rates of color degradation in a display 12 that uses red, green and blue pixels for example, the calibration can rely on turning on and measuring all the red pixels as one operation turning on and measuring all the green pixels as another operation, and turning on and measuring all the blue pixels as a further operation. Alternatively, if the optical sensor is an RGB sensor, all the pixels of the display can be energized and measured as one operation, and the red, green and blue outputs of the sensor used for correcting for the different rates of color degradation.

For each of the arrangements of FIGS. 1-7, the light measurements can be analyzed for calibration by electronics that are in adjunct 1 and/or in device 11.

For cases where it is opted to use a camera for sensor 2, the camera can take a set, for example sixteen, of pictures of display 12, each picture being for measuring an is associated one sixteenth of the pixels of display 12. The turned-on/measured pixels are in this case separated from each other by three dark pixels vertically and three dark pixels horizontally. This helps to reduce the resolution required from the camera. The lens of the digital camera can be defocused slightly, so that light from one pixel of display 12 strikes more than one of the camera pixels. FIG. 9 illustrates a further laptop computer arrangement. In this case sensor 2, for sensing display 12, is retractable downwards into main body 11 when not in use.

For each of the arrangements of FIGS. 1-9, display 12 can be an OLED display or it can be any other type of display.

1-15. (canceled)

16. A monitoring device for a rechargeable personal portable device of the type having a main body to which is attached a display, said monitoring device being coupled to a portion of said main body at least temporarily and including at least one optical device provided for calibrating the display, the monitoring device serving to recharge a battery of the personal portable device.

17. A monitoring device according to claim 16, wherein said optical device comprises a light sensor.

18. A monitoring device according to claim 17, wherein said light sensor is spaced away from said display during monitoring of the display by monitoring device.

19. A monitoring device according to claim 17, wherein said light sensor is a camera.

20. A monitoring device according to claim 17, wherein said portable device is a laptop computer and said sensor is a camera.

21. A monitoring device according to claim 17, wherein said sensor is a camera having a lens with an optical axis, the camera having a sensor array the plane of which is oblique to the optical axis.

22. A monitoring device according to claim 17, wherein said portable device has a main body with a hinge for a display at one end of the main body sand wherein said sensor is a camera placed near an opposite end of the main body.

23. A monitoring device according to claim 16, wherein said monitoring device is a cradle.

24. A monitoring device according to claim 16, wherein a pixel of said display is driven so that its emitted light is modulated and wherein the modulated light is detected by means selective to the modulation.

25. A monitoring device according to claim 16, wherein a pixel of said display is driven so that its emitted light is modulated by a repetitive signal and wherein the modulated light is detected by means selective to the repetition rate of said signal.

26. A monitoring device according to claim 25, wherein said camera is of lower resolution than said display.

27. A monitoring device according to claim 16, wherein said monitoring device comprises an electrical connector carrying an optical device used for calibration of said display.

28. A monitoring device according to claim 16, wherein said display is an OLED display.

29. A monitoring device according to claim 16, wherein said optical device comprises a reflector serving to reflect light from the display towards a light sensor.

30. A monitoring device according to claim 16, wherein said optical device is a light-guide serving to direct light from the display to a light sensor.

31. A rechargeable personal portable device comprising: a body having first and second outer sides, opposite each other; a display hinged to said body at said first side; an optical monitoring device mechanically coupled, at least temporarily, to a portion of the body that is at or in the vicinity of said second side, the optical monitoring device serving in re-calibrating the display.

32. A portable device according to claim 31, wherein the optical monitoring device comprises a light sensor.

33. A portable device according to claim 32, wherein the optical monitoring device comprises a connector used in charging a battery of the portable device.

34. A portable device according to claim 32, wherein said display is an OLED display and wherein said light sensor is a camera.

35. A portable device according to claim 34, wherein said camera protrudes from said body during re-calibration and can be retracted into the body during normal use of the portable device.

36. A portable device according to claim 32, wherein said body comprises a keyboard.
